(19) United States
(12) Patent Application Publication
(10) Pub. No.: US 2016/0266784 A1
(43) Pub. Date: Sep. 15, 2016

(54) METHOD AND DEVICE FOR ADJUSTING VIDEO PLAYBACK INTERFACE

(71) Applicant: LEMOBILE INFORMATION TECHNOLOGY (BEIJING) CO., LTD., Beijing (CN)

(72) Inventors: Shaopeng YU, Beijing (CN); Fan LIANG, Beijing (CN)

(21) Appl. No.: 15/033,614

(22) PCT Filed: Oct. 22, 2014
(86) PCT No.: PCT/CN2014/089195

§ 371 Date: Apr. 29, 2016

(30) Foreign Application Priority Data
Oct. 30, 2013 (CN) 201310530267.7

(51) Int. Cl. G06F 3/0484; G06F 17/22

(52) U.S. Cl. CPC G06F 3/04847; G06F 17/2247

(57) ABSTRACT

Disclosed are a method and device for adjusting video playback interface. The method comprises: a browser opening a webpage where a target network video is located on the basis of a received request message requesting for the target network video, acquiring a video tag of the webpage, parsing the video tag to obtain a display size of the target network video in the page and actual playback address of the video, and then invoking a player in the smart television; the player receiving a call request, acquiring the target network video on the basis of the actual playback address of target network video, and stretching the display size of the target network video in the page on the basis of the full-screen size of the smart television, to allow for the full-screen playback of the target network video on a screen of the smart television. With such a method, after the target network video is selected, in the process of invoking the player to play back the target network video, the player can automatically stretch the target network video on the basis of the screen size of the smart television, such that the playback size of the video reaches full screen without user's manual operation and thus the user experience can be improved.

The present disclosure is a national stage of International Application No. PCT/CN2014/089195, filed Oct. 22, 2014, which claims priority from Chinese Patent Application No. 201310530267.7, titled “METHOD AND DEVICE FOR ADJUSTING VIDEO PLAYBACK INTERFACE”, filed on Oct. 30, 2013 in the Chinese Intellectual Property Office, the contents of which in its entirety are herein incorporated by reference.

### FIELD OF TECHNOLOGY

The present disclosure generally relates to the field of smart television, and more particularly, to a method and a device for adjusting video playback interface.

### BACKGROUND

Television is most common household electrical appliances in modern society. With the development of sciences and technologies, smart television having a full-open platform and provided with an operating system has emerged. A user can install and uninstall various applications by himself or herself while enjoying general television programs through the smart television, so that functions of the smart television can be continuously extended and updated to provide abundant and personalized experience for the user.

The smart television can realize webpage browsing and play back a video in a webpage.

However, when playing the videos on the network, the smart television in the prior art acquire video source via the webpage to directly play back at an original aspect ratio. As a result, the video can only be played back on the basis of the video window of the webpage. Since the size of television screen is normally much larger than the size of the video window, when the user is watching a network video on the smart television, the size of the video played back on the television screen is less than the size of the television screen. Therefore, a black bar is formed between the television screen and the video, which may cause an undesirable watching effect to the user. In the case that the user would like to watch on a full-screen or with the size scaled, he/she is requested to manually click a “Full-Screen” button set in the website. Thus, the video is stretched and then played back. Thus, operating process is complicated and the user's experience is deteriorated.

### SUMMARY

In light of this, one of objectives of the present disclosure is to provide a method and device for adjusting video playback interface. When a user selects a video, the size of video playback can be automatically enlarged to a full-screen state of the smart television without user's manual operation, and thus the user experience can be improved.

A method for adjusting video playback interface, applicable to a smart television, includes steps of:

a browser opening a webpage where a target network video is located on the basis of a received request message requesting for the target network video;

the browser acquiring a video tag of the webpage, and parsing the video tag to obtain a display size of the target network video in the page and actual playback address of the video;

the browser invoking the player in the smart television;

the player receiving a call request of the browser and acquiring the target network video on the basis of the received actual playback address of the target network video to be played back as requested; and

the player stretching the display size of the target network video in the page on the basis of the full-screen size of the smart television, to allow for the full-screen playback of the target network video on a screen of the smart television.

According to above method, in an embodiment of the present disclosure, the size includes a height and a width, and the step of the player stretching the display size of the target network video in the page on the basis of the full-screen size of the smart television, includes:

the player stretching a width of the target network video as displayed in the page to a width of the full-screen size; and

the player stretching a height of the target network video as displayed in the page to a height of the full-screen size.

According to above method, in an embodiment of the present disclosure, the step of the browser acquiring a video tag of the webpage and parsing the video tag to obtain a display size of the target network video in the page and actual playback address of the video, includes:

acquiring a tag a of the webpage and acquiring webpage address URL of the target network video on the basis of the tag a;

loading a corresponding HTML5 video page which includes a HTML5 video tag on the basis of the URL; and

invoking a JavaScript function to parse the HTML5 video tag, to obtain the display size of the target network video in the page and the actual playback address of the video.

According to above method, in an embodiment of the present disclosure, after the step of acquiring the target network video on the basis of the received actual playback address of the target network video to be played back as requested, and before the step of the player stretching the display size of the target network video in the page on the basis of the full-screen size of the smart television, the method further includes:

the player calculating out a ratio of the target network video on the basis of the display size of the target network video in the page and judging whether the ratio of the target network video falls into a predefined stretchable range, and if yes, stretching the display size of the target network video in the page to the full-screen size;

otherwise, playing back the target network video with the display size of the target network video in the page.

According to above method, in an embodiment of the present disclosure, the predefined stretchable range is a range in which the stretched target network video is not subjected to distortion, including: a 0.8˜1.2 ratio of the aspect ratio of the full-screen size of the smart television to the target network video ratio, wherein the target network video ratio is an aspect ratio of the display size of the target network video in the page.

According to above method, in an embodiment of the present disclosure, after the step of acquiring the target network video on the basis of the received actual playback address of the target network video to be played back as requested, and before the step of the player stretching the display size of the target network video in the page on the basis of the full-screen size of the smart television, the method further includes:

the player generating an inquiry message to inquire whether to play back on full screen and displaying it on the smart television screen;

when receiving a message to determine the full-screen playback, the player stretching the display size of the target network video in the page on the basis of the full-screen size of the smart television;

otherwise, the player playing back the target network video with the display size of the target network video in the page.

A device for adjusting video playback interface, applicable to a smart television, includes a browser and a player, wherein

the browser is configured to open a webpage where a target network video is located on the basis of received request message requesting for the target network video, acquire a video tag of the webpage, parse the video tag to obtain a display size of the target network video in the page and actual playback address of the video, and invoke the player in the smart television; and

the player is configured to receive a call request of the browser, acquire the target network video on the basis of the received actual playback address of the target network video to be played back as requested, and stretch the display size of the target network video in the page on the basis of the full-screen size of the smart television to allow for a full-screen playback of the target network video on a screen of the smart television.

According to above device, in an embodiment of the present disclosure, the browser includes: a network module, an acquiring module, a parsing module and an invoking module, wherein

the network module is configured to open a webpage where a target network video is located on the basis of received request message requesting for the target network video;

the acquiring module is configure to acquire a video tag of the webpage;

the parsing module is configure to parse the video tag to obtain a display size of the target network video in the page and actual playback address of the video; and

the invoking module is configured to invoke the player in the smart television, and

the player includes: a receiving module, an acquiring module, and a stretching module, wherein

the receiving module is configured to receive the call request;

the acquiring module is configure to acquire the target network video on the basis of the received actual playback address of the target network video to be played back as requested; and

the stretching module is configured to stretch the display size of the target network video in the page on the basis of the full-screen size of the smart television, to allow for the full-screen playback of the target network video on the screen of the smart television.

According to above device, in an embodiment of the present disclosure, the parsing module includes:

an address acquiring module, configured to acquire a tag a of the webpage and acquire webpage address URL of the target network video on the basis of the tag a;

a loading module, configured to, on the basis of the URL, load a corresponding HTML5 video page which includes a HTML5 video tag; and

an invoking module, configured to invoke a JavaScript function to parse the HTML5 video tag, to obtain the display size of the target network video in the page and the actual playback address of the video.

According to above device, in an embodiment of the present disclosure, the size includes a height and a width, and the stretching module includes:

a first stretching module, configured to stretch a width of the target network video as displayed in the page to a width of the full-screen size; and

a second stretching module, configured to stretch a height of the target network video as displayed in the page to a height of the full-screen size.

A computer readable recording medium having computer programs stored thereon that, when executed by one or more processors of an electronic apparatus, cause the electronic apparatus to perform:

a browser opening a webpage where a target network video is located on the basis of a received request message requesting for the target network video;

the browser acquiring a video tag of the webpage, and parsing the video tag to obtain a display size of the target network video in the page and actual playback address of the video;

the browser invoking the player in the smart television;

the player receiving a call request of the browser and acquiring the target network video on the basis of the received actual playback address of the target network video to be played back as requested; and

the player stretching the display size of the target network video in the page on the basis of the full-screen size of the smart television, to allow for the full-screen playback of the target network video on a screen of the smart television.

There is further provided a smart television for adjusting video playback interface, characterized in that, the smart television includes:

a memory having instructions stored thereon;

a processor configured to execute the instructions to perform operations for adjusting video playback interface, comprising:

opening a webpage where a target network video is located on the basis of received request message requesting for the target network video, acquiring a video tag of the webpage, parsing the video tag to obtain a display size of the target network video in the page and actual playback address of the video, and invoking the player in the smart television; and

receiving a call request of the browser, acquiring the target network video on the basis of the received actual playback address of the target network video to be played back as requested, and stretching the display size of the target network video in the page on the basis of the full-screen size of the smart television to allow for a full-screen playback of the target network video on a screen of the smart television.

The method for adjusting video playback interface according to the present disclosure may include: a browser opening a webpage where a target network video is located on the basis of a received request message requesting for the target network video; the browser acquiring a video tag of the webpage, and parsing the video tag to obtain a display size of the target network video in the page and actual playback address of the video; the browser invoking a player in the smart television; the player receiving a call request, and acquiring the target network video on the basis of the received actual playback address of the target network video to be played back as requested; and the player stretching the display size of the target network video in the page on the basis of the full-screen size of the smart television, to allow for the full-screen playback of the target network video on a screen of the smart television. With such a method, after the target network video is selected, in the process of invoking the player to play back the target network video, the player can automatically stretch the target network video on the basis of the screen size of the smart television, such that the playback size of the video reaches full screen without user's manual operation and thus the user experience can be improved.

### BRIEF DESCRIPTION OF THE DRAWINGS

In order to more apparently describe the technical schemes in the embodiments of the present disclosure or in the prior art, accompanying figures necessarily used in the description of the embodiments or the prior art will be simply explained hereinafter. Obviously, the accompanying figures described below will form the embodiments of the present disclosure. An ordinary person skilled in the art may conceive further figures in accordance with these accompanying figures without contributing creative labor.

FIG. 1 is a flow chart of a method for adjusting video playback interface according to an embodiment of the present disclosure;

FIG. 2 is a flow chart of a method for adjusting video playback interface according to another embodiment of the present disclosure;

FIG. 3 is a flow chart of a method for adjusting video playback interface according to another embodiment of the present disclosure;

FIG. 4 is a flow chart of a method for adjusting video playback interface according to another embodiment of the present disclosure;

FIG. 5 is a flow chart of a method for adjusting video playback interface according to another embodiment of the present disclosure;

FIG. 6 is a structural schematic diagram of a device for adjusting video playback interface according to an embodiment of the present disclosure;

FIG. 7 is a structural schematic diagram of a browser in a device for adjusting video playback interface according to another embodiment of the present disclosure;

FIG. 8 is a structural schematic diagram of a player in a device for adjusting video playback interface according to another embodiment of the present disclosure;

FIG. 9 is a structural schematic diagram of a browser in a device for adjusting video playback interface according to another embodiment of the present disclosure;

FIG. 10 is a structural schematic diagram of a device for adjusting video playback interface according to another embodiment of the present disclosure;

FIG. 11 is a flow chart of an application scenario of the method for adjusting video playback interface according to the present disclosure;

FIG. 12 is a flow chart of another application scenario of the method for adjusting video playback interface according to the present disclosure;

FIG. 13 is a schematic diagram of a dialog box in another application scenario of the method for adjusting video playback interface according the present disclosure;

FIG. 14 is a flow chart of another application scenario of the method for adjusting video playback interface according to the present disclosure; and

FIG. 15 is a schematic diagram of a smart television screen in another application scenario of the method for adjusting video playback interface according to the present disclosure.

### DESCRIPTION OF THE EMBODIMENTS

In order that objectives, technical schemes and advantages of the embodiments of the present disclosure become more apparent, the technical schemes in the embodiments of the present disclosure will be thoroughly and completely described below in conjunction with the accompanying figures in the embodiments of the present disclosure. It is obvious that the embodiments described herein are some of embodiments of the present disclosure rather than entire embodiments. On the basis of the embodiments of the present disclosure, other embodiments conceived by an ordinary person skilled in the art without creative labor would all fall into the scope of the present disclosure.

The method and device for adjusting video playback interface involved in the embodiments of the present disclosure are applicable to the smart television to play back the network videos.

The browser involved in the present disclosure is a client browsing program of World Wide Web (web) service, which can send requests to a Web server and which can explain, display and play hypertext information and a variety of multimedia data formats from the serve. The hypertext information uses HTML (Hyper Text Markup Language). The HTML is a markup language involved in “Information of webpage creation and other information seen in the webpage browser”.

The player involved in the present disclosure may be software capable of playing video or audio files stored in the form of digital signal. The software installed on the smart television can include a variety of players, such as media player and RealPlayer.

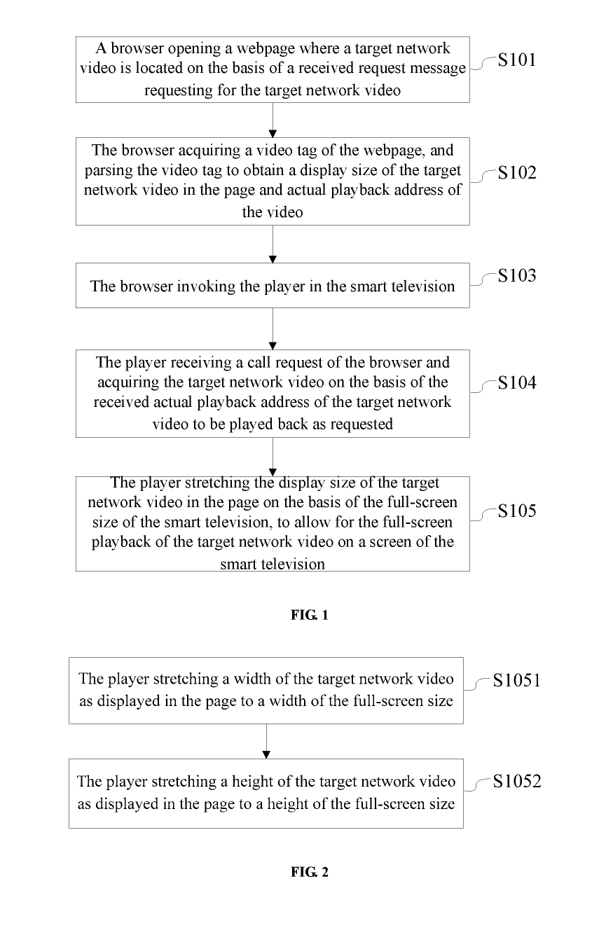

As shown in FIG. 1, the flow chart of the method for adjusting video playback interface provided in an embodiment of the present disclosure may include:

Step S101: a browser opening a webpage where a target network video is located on the basis of a received request message requesting for the target network video.

When a user is watching the network video on the smart television, if the user would like to watch a target network video, he or she could click a tag of the target network video (such as, icon or prompt message) in current webpage, to generate request message requesting for the target network video. The browser could receive the request message and open the webpage where the target network video is located on the basis of the request message.

Step S102: the browser acquiring a video tag of the webpage, and parsing the video tag to obtain a display size of the target network video in the page and actual playback address of the video.

The browser could acquire the video tag in the webpage where the target network video is located. The video tag is a dedicated of the target network video. The video tag may be parsed to obtain the display size of the target network video in the page and the actual playback address of the video.

The display size of the target network video in the page refers to an initial size of the target network video, and in particular may employ a variety of available video sizes currently used, such as 1280×720, 1024×576 and 1024×552.

Step S103: the browser invoking the player in the smart television.

The smart television is provided with the player which is used to play back the video and audio information on the network or stored in memory storage of the smart television.

After acquiring the actual playback address of the target network video and its display size in the page, the browser may send the call request for invoking the player, in order to play back the target network video on the smart television by the player.

Step S104: the player receiving a call request of the browser and acquiring the target network video on the basis of the received actual playback address of the target network video to be played back as requested.

The player may receive the call request from the browser and start to behave.

While the browser is invoking the player, it may send the actual playback address of the target network video to be played back as requested. The player may acquire the target network video according to the actual playback address.

In particular, the actual playback address can be used to set playback address of the player, and the player can acquire corresponding video according to its playback address.

Step S105: the player stretching the display size of the target network video in the page on the basis of the full-screen size of the smart television, to allow for the full-screen playback of the target network video on a screen of the smart television.

The full-screen size of the smart television may be preset in the player or set in the memory of the smart television. When the player is activated, it can acquire the full-screen size from the memory storage.

The player can stretch the target network video on the basis of the full-screen size of the smart television to fill the screen of the smart television with the target network video during playback, thereby allowing for the full-screen playback on the screen of the smart television.

In particular, the full-screen size can be used to set the playback size of the player. When the player is playing back the acquired target network video, it may employ such a playback size to play back the target network information on the full screen.

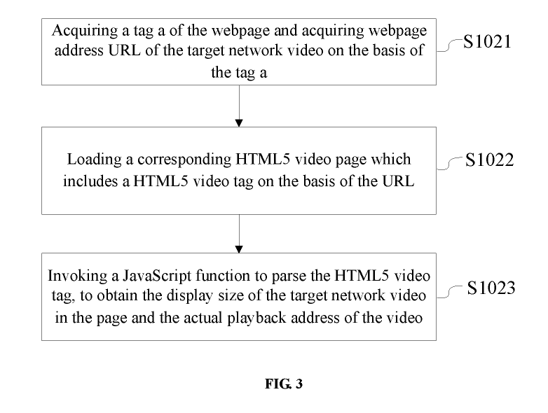

In a practical implementation, the size includes a height and a width. With reference to FIG. 2, it shows a flow chart of the method for adjusting video playback interface according to another embodiment of the present disclosure. Step S105 may include:

Step S1051: the player stretching a width of the target network video as displayed in the page to a width of the full-screen size.

When the target network video is stretched by the player on the basis of the full-screen size of the smart television, it can be stretched in both width and height direction.

The player can stretch the width of the target network video as displayed in the page to the width of the full-screen size on the basis of the width of the full-screen size of the smart television, such that the playback width of target network video reaches the width of the full-screen.

Step S1052: the player stretching a height of the target network video as displayed in the page to a height of the full-screen size.

The player can stretch the height of the target network video as displayed in the page to the height of the full-screen size on the basis of the height of the full-screen size of the smart television, such that the playback height of target network video reaches the height of the full-screen.

Although, in this embodiment, the width of the target network video is first stretched and then the height thereof is stretched in the stretching process of the target network video, the present disclosure is not limited thereto. In practical implementation, the height may be first stretched and then the width is stretched, or the width and the height can be stretched simultaneously. This could be embodied dependently on practical application scenarios.

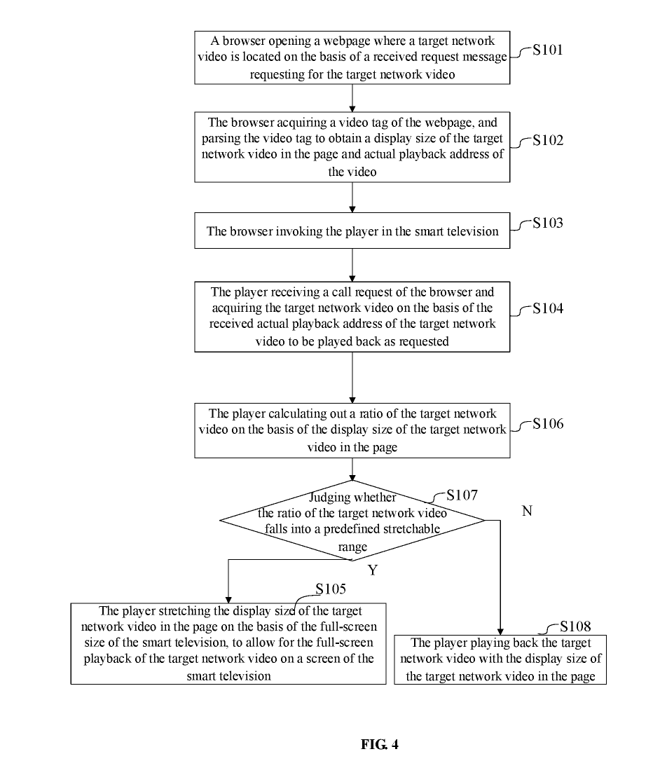

With reference to FIG. 3, in another specific flow chart of a method for adjusting video playback interface provided in the first embodiment of the present disclosure, Step S102 may include:

Step S1021: acquiring a tag a of the webpage and acquiring webpage address URL of the target network video on the basis of the tag a.

The tag a in HTML can define an anchor. The anchor has following two usages. In one usage, a link (or hyperlink) pointing to another document is created by using href attribute; and in another usage, a bookmark inside the document is created (that is, a link pointing to document fragment can be created) by using name or id attribute. The most important attribute of the element a is the href attribute, which points to a target of the link.

The browser can acquire the tag a of the webpage, and then, on the basis of the tag a, the target of the link to which the tag a points (that is, the webpage address URL of the target network video) can be acquired.

Step S1022: loading a corresponding HTML5 video page which includes a HTML5 video tag on the basis of the URL.

The HTML5 video tag is also known as a Video tag.

The HTML5 is a next main revised version of HTML.

On the basis of the URL, the browser can load the corresponding HTML5 video page which includes the HTML5 video tag.

Step S1023: invoking a JavaScript function to parse the HTML5 video tag, to obtain the display size of the target network video in the page and the actual playback address of the video.

Since the HTML5 video tag (i.e., Video tag) contains attributes of scr, poster, preload, autoplay, loop, controls, width and height and a tag for internal use, the browser can invoke the JS (JavaScript) function to parse the video tag to obtain the display size of the target network video in the page: width and height, and actual address scr of the target network video.

The JS function can be used to analyze parameters in the Video tag of the target network video, to acquire the display size of the target network video in the page and the actual playback address thereof, providing parameters for subsequently invoking the player to perform the stretching actions.

In conclusion, the method for adjusting video playback interface provided in this embodiment may include: a browser opening a webpage where a target network video is located on the basis of received request message requesting for the target network video; the browser acquiring a video tag of the webpage and parsing the video tag to obtain a display size of the target network video in the page and actual playback address of the video; the browser invoking the player in the smart television; the player receiving a call request of the browser and acquiring the target network video on the basis of the received actual playback address of the target network video to be played back as requested; and the player stretching the display size of the target network video in the page on the basis of the full-screen size of the smart television, to allow for a full-screen playback of the target network video on a screen of the smart television. With such a method, after the target network video is selected, in the process of invoking the player to play back the target network video, the player can automatically stretch the target network video on the basis of the screen size of the smart television, such that the playback size of the video reaches full screen without user's manual operation and thus the user experience can be improved.

With reference to FIG. 4, it shows a flow chart of a method for adjusting video playback interface according to another embodiment of the present disclosure. In the flow chart as shown in FIG. 1, following steps may be further included between Step S104 and Step S105:

Step S106: the player calculating out a ratio of the target network video on the basis of the display size of the target network video in the page.

According to the display size of the target network video in the page, it is possible to calculate out the ratio of the target network video. For example, when the display size of the target network video in the page is 1280×720, the ratio is calculated out as 16:9.

Step S107: judging whether the ratio of the target network video falls into a predefined stretchable range, and if yes, proceeding to Step S105 which includes: stretching the display size of the target network video in the page to the full-screen size; otherwise, proceeding to Step S108.

Since, in the process of stretching, there is a difference between the size of the target network video and the full-screen size of the smart television, the stretched target network video may be subjected to image distortion when being displayed on the full screen. Once the image distortion occurs, it may interfere with user's watching effect and deteriorate user experience. Therefore, when the target network video ratio falls into the predefined stretchable range, i.e., it is stretched without distortion, proceed to Step S105 to stretch the target network video; otherwise, proceed to Step S108 not to stretch it.

The predefined stretchable range is a range in which the stretched target network video is not subjected to distortion, including: a 0.8˜1.2 ratio of the aspect ratio of the full-screen size of the smart television to the target network video ratio, wherein the target network video ratio is an aspect ratio of the display size of the target network video in the page.

Step S108: the player playing back the target network video with the display size of the target network video in the page.

When the target network video ratio does not fall into the predefined stretchable range, i.e., it is stretched with distortion, the player will not stretch and play back the target network video on the full screen rather than playing back the target network video with the display size of the video in the page.

In conclusion, the method for adjusting video playback interface provided in this embodiment may further include: the player calculating out a ratio of the target network video on the basis of the display size of the target network video in the page; judging whether the ratio of the target network video falls into a predefined stretchable range, if yes, stretching the display size of the target network video in the page to the full-screen size; otherwise, playing back the target network video with the display size of the target network video in the page. The target network video will be stretched when it falls into the stretching requirement; otherwise not stretched, thereby ensuring that the stretched video images are played back without distortion so as to provide higher user experience.

As shown in FIG. 5, there is provided a flow chart of a method for adjusting video playback interface. In the flow chart as shown in FIG. 1, following steps may be further included between Step S104 and Step S105:

Step S109: the player generating an inquiry message to inquire whether to play back on full screen and displaying it on the smart television screen.

The user may determine whether to play back on full screen according to his/her own preference or habits. Before stretching the target network video, the player may generate the inquiry message to inquire whether to play back on full screen and display the inquiry message on the smart television screen to provide the user with option to stretch or not. The user may choose to play back on full screen or not to play back on full screen by himself or herself via a controller (such as a remote control). A feedback message can be generated and sent to the smart television.

Step S110: judging whether the received message is a message to determine the full-screen playback, and if yes, proceeding to Step S105 which includes: the player stretching the display size of the target network video in the page on the basis of the full-screen size of the smart television; otherwise, proceeding to Step S111.

After receiving the feedback message, the player may judge whether the message is a message to determine the full-screen playback. If yes, proceed to Step S105 which includes: stretching the display size of the target network video in the page on the basis of the full-screen size of the smart television, to allow for the full-screen playback of the target network video on the screen of the smart television.

Step S111: the player playing back the target network video with the display size of the target network video in the page.

If the message acquired by the player is not a message to determine the full screen playback, then the full screen playback would be negated. In this regard, the player will no longer stretch the target network video, but play back the target network video with the display size of the video in the page.

In conclusion, the method for adjusting video playback interface provided in this embodiment may further include: the player generating an inquiry message to inquire whether to play back on full screen and displaying it on the smart television screen; when a message to determine the full screen playback is received, the player stretching the display size of the target network video in the page on the basis of the full-screen size of the smart television; otherwise, the player playing back the target network video at the display size of the target network video in the page. Before the target network video is stretched, the player can propose an inquiry message to inquire whether to stretch. The user may determine whether to stretch on the basis of his or her own use habits, thereby improving user's participation and providing better user experience.

The present disclosure also provides a computer readable recording medium in which a program configured to execute above methods is recorded.

The computer readable recording medium may include any mechanism for storing or transmitting information in a readable form of a computing device (e.g., a computer). For example, the machine readable medium includes Read Only Memory (ROM), Random Access Memory (RAM), magnetic disk storage medium, optical storage medium, flash memory medium, and propagation signals (e.g., carrier wave, infrared signals, digital signals, etc.) in the forms of electrics, optics, acoustics or any other forms.

Correspondingly to the embodiments of the method for adjusting video playback interface, there is also provided the embodiments of the device for adjusting video playback interface in the specification of the present disclosure.

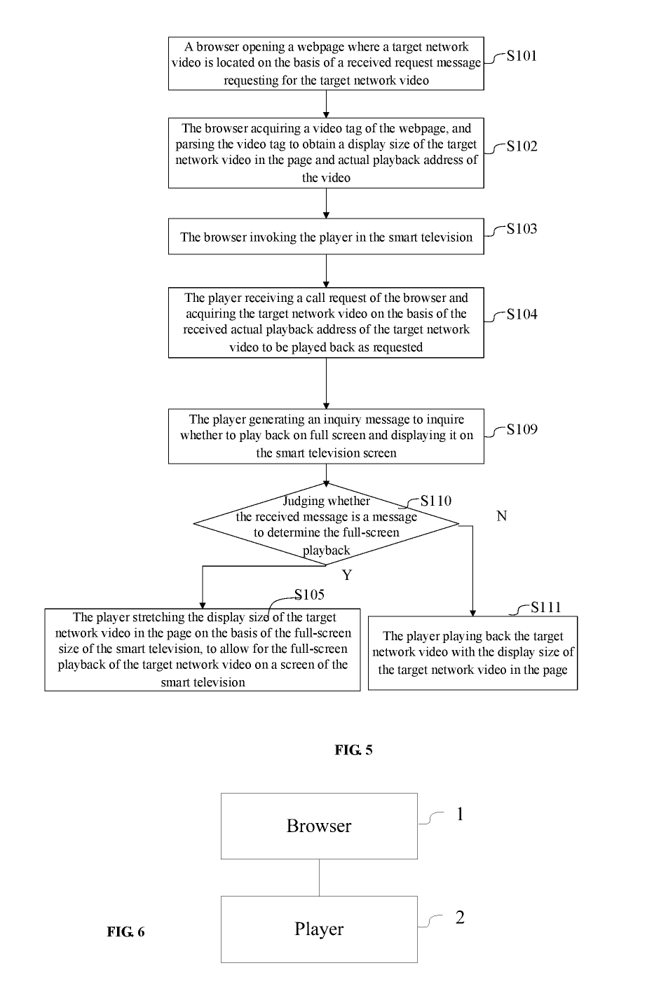

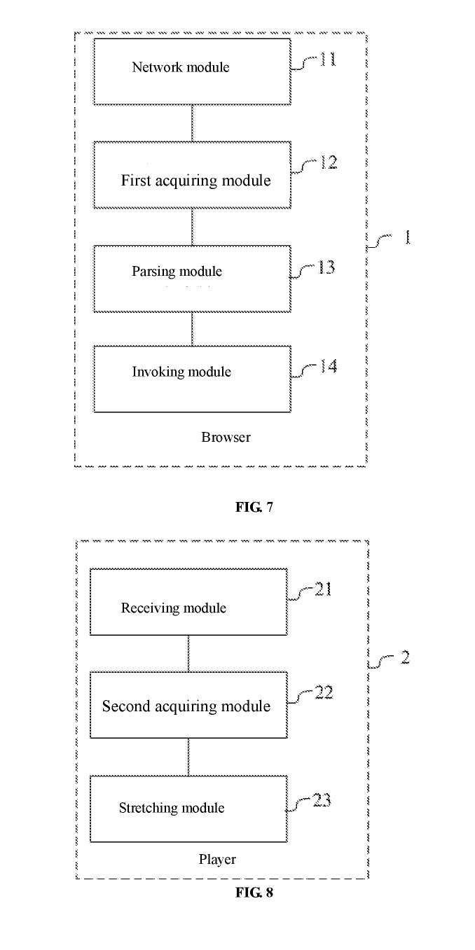

With reference to FIG. 6, it shows a structural schematic diagram of a device for adjusting video playback interface according to an embodiment of the present disclosure. The device may include: a browser 1 and a player 2.

Herein, the browser 1 is configured to open a webpage where a target network video is located on the basis of received request message requesting for the target network video, acquire a video tag of the webpage, parse the video tag to obtain a display size of the target network video in the page and actual playback address of the video, and invoke the player in the smart television;

The player 2 is configured to receive a call request of the browser 1, acquire the target network video on the basis of the received actual playback address of the target network video to be played back as requested, and stretch the display size of the target network video in the page on the basis of the full-screen size of the smart television to allow for a full-screen playback of the target network video on a screen of the smart television.

With reference to FIG. 7, it shows a structural schematic diagram of a browser in a device for adjusting video playback interface according to another embodiment of the present disclosure. The browser 1 may include: a network module 11, a first acquiring module 12, a parsing module 13 and an invoking module 14.

Herein, the network module 11 is configured to open a webpage where a target network video is located on the basis of received request message requesting for the target network video.

When a user is watching the network video on the smart television, if the user would like to watch a target network video, he or she could click a tag of the target network video (such as, icon or prompt message) in current webpage, to generate request message requesting for the target network video. The network module 11 of the browser 1 could receive the request message and open the webpage where the target network video is located on the basis of the request message.

Herein, the first acquiring module 12 is configure to acquire a video tag of the webpage; the parsing module 13 is configure to parse the video tag to obtain a display size of the target network video in the page and actual playback address of the video.

The first acquiring module 12 of the browser 1 could acquire the video tag in the webpage where the target network video is located. The video tag is a dedicated of the target network video. The parsing module 13 could parse the video tag to obtain the display size of the target network video in the page and the actual playback address of the video.

The display size of the target network video in the page refers to an initial size of the target network video, and in particular may employ a variety of available video sizes currently used, such as 1280×720,1024×576, 1024×552.

Herein, the invoking module 14 is configured to invoke the player in the smart television.

The smart television is provided with the player 2 which is used to play back the video and audio information on the network or stored in memory storage of the smart television.

After the browser 1 acquires the actual playback address of the target network video and its display size in the page, the invoking module 14 may send the call request for invoking the player 2, in order to play back the target network video on the smart television by the player 2.

With reference to FIG. 8, it shows a structural schematic diagram of a player in a device for adjusting video playback interface according to another embodiment of the present disclosure. The player 2 may include: a receiving module 21, a second acquiring module 22 and a stretching module 23;

Herein, the receiving module 21 is configured to receive the call request, and the second acquiring module 22 is configured to acquire the target network video on the basis of the received actual playback address of the target network video to be played back as requested.

The receiving module 21 of the player 2 may receive the call request from the browser and start to behave.

While the browser 1 is invoking the player 2, it may send the actual playback address of the target network video to be played back as requested. The second acquiring module 22 may acquire the target network video according to the actual playback address.

In particular, the actual playback address can be used to set playback address of the player, and the player can acquire corresponding video according to its playback address.

Herein, the stretching module 23 is configured to stretch the display size of the target network video in the page on the basis of the full-screen size of the smart television, to allow for the full-screen playback of the target network video on the screen of the smart television.

The full-screen size of the smart television may be preset in the player or set in the memory of the smart television. When the player is activated, it can acquire the full-screen size from the memory storage.

The stretching module 23 can stretch the target network video on the basis of the full-screen size of the smart television to fill the screen of the smart television with the target network video during playback, thereby allowing for the full-screen playback on the screen of the smart television.

In particular, the full-screen size can be used to set the playback size of the player. When the player is playing back the acquired target network video, it may employ such a playback size to play back the target network information on the full screen.

In a practical implementation, the size includes a height and a width. The stretching module 23 may include: a first stretching module and a second stretching module.

Herein, the first stretching module is configured to stretch a width of the target network video as displayed in the page to a width of the full-screen size.

When the target network video is stretched by the player on the basis of the full-screen size of the smart television, the first stretching module and the second stretching module can realize to stretch in both width and height direction.

The first stretching module can stretch the width of the target network video as displayed in the page to the width of the full-screen size on the basis of the width of the full-screen size of the smart television, such that the playback width of target network video reaches the width of the full-screen.

Herein, the second stretching module is configured to stretch a height of the target network video as displayed in the page to a height of the full-screen size.

The second stretching module can stretch the height of the target network video as displayed in the page to the height of the full-screen size on the basis of the height of the full-screen size of the smart television, such that the playback height of target network video reaches the height of the full-screen.

Although, in this embodiment, the width of the target network video is first stretched and then the height thereof is stretched in the stretching process of the target network video, the present disclosure is not limited thereto. In practical implementation, the height may be first stretched and then the width is stretched, or the width and the height can be stretched simultaneously. This could be embodied dependently on practical application scenarios.

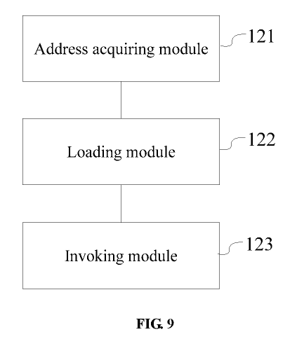

With reference to FIG. 9, it shows a structural schematic diagram of a browser in a device for adjusting video playback interface according to another embodiment of the present disclosure. The parsing module 12 of the browser 1 may include: an address acquiring module 121, a loading module 122 and an invoking module 123.

Herein, the address acquiring module 121 is configured to acquire a tag a of the webpage and acquire webpage address URL of the target network video on the basis of the tag a.

The tag a in HTML can define an anchor. The anchor has following two usages. In one usage, a link (or hyperlink) pointing to another document is created by using href attribute; and in another usage, a bookmark inside the document is created (that is, a link pointing to document fragment can be created) by using name or id attribute. The most important attribute of the element a is the href attribute, which points to a target of the link.

The address acquiring module 121 can acquire the tag a of the webpage, and then, on the basis of the tag a, the target of the link to which the tag a points (that is, the webpage address URL of the target network video) can be acquired.

Herein, the loading module 122 is configured to, on the basis of the URL, load a corresponding HTML5 video page which includes a HTML5 video tag.

The HTML5 is a next main revised version of HTML.

The loading module 122, on the basis of the URL, can load the corresponding HTML5 video page. This video page includes the HTML5 video tag which is also known as a Video tag.

Herein, the invoking module 123 is configured to invoke a JavaScript function to parse the HTML5 video tag, to obtain the display size of the target network video in the page and the actual playback address of the video.

Since the HTML5 video tag (i.e., Video tag) contains attributes of scr, poster, preload, autoplay, loop, controls, width and height and a tag for internal use, the invoking module 123 can invoke the JS (JavaScript) function to parse the video tag to obtain the display size of the target network video in the page: width and height, and actual address scr of the target network video.

The JS function can be used to analyze parameters in the Video tag of the target network video, to acquire the display size of the target network video in the page and the actual playback address thereof, providing parameters for subsequently invoking the player to perform the stretching actions.

In conclusion, the device for adjusting video playback interface provided in this embodiment may include: a browser opening a webpage where a target network video is located on the basis of received request message requesting for the target network video; the browser acquiring a video tag of the webpage and parsing the video tag to obtain a display size of the target network video in the page and actual playback address of the video; the browser invoking the player in the smart television; the player receiving a call request of the browser and acquiring the target network video on the basis of the received actual playback address of the target network video to be played back as requested; and the player stretching the display size of the target network video in the page on the basis of the full-screen size of the smart television, to allow for a full-screen playback of the target network video on a screen of the smart television. With such a device, after the target network video is selected, in the process of invoking the player to play back the target network video, the player can automatically stretch the target network video on the basis of the screen of the smart television, such that the playback size of the video reaches full screen without user's manual operation and thus the user experience can be improved.

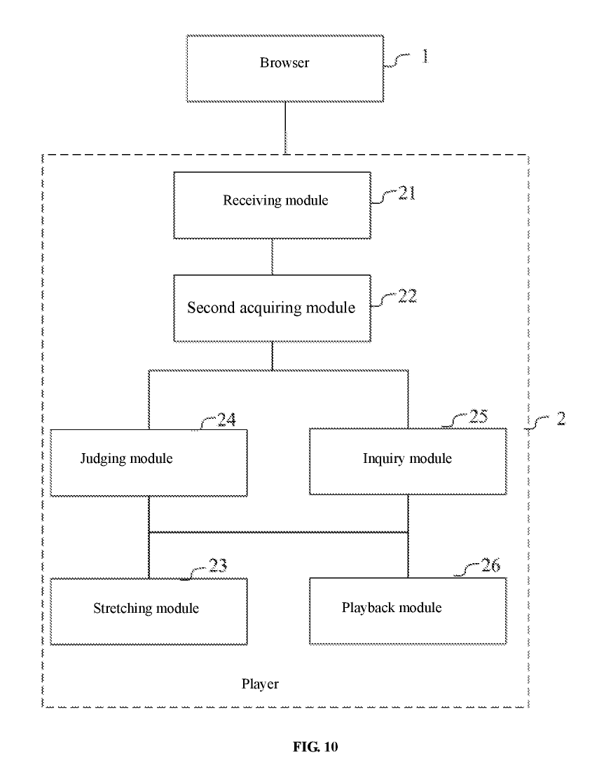

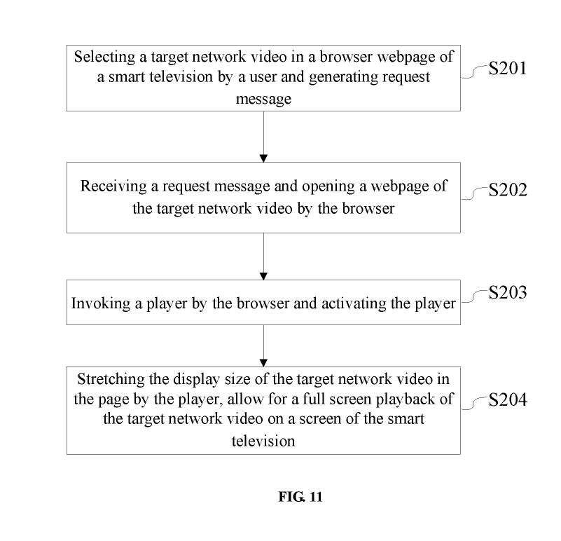

With reference to FIG. 10, it shows a structural schematic diagram of a device for adjusting video playback interface according to another embodiment of the present disclosure. In the structure as shown in FIG. 6 and FIG.8, the player 2 may further include: a judging module 24, an inquiry module 25 and a playback module 26.

Herein, the judging module 24 is configured to calculate out a ratio of the target network video on the basis of the display size of the target network video in the page, judge whether the ratio of the target network video falls into a predefined stretchable range, and if yes, trigger the stretching module 23; otherwise, trigger the playback module 26.

According to the display size of the target network video in the page, the judging module 24 can calculate out the ratio of the target network video. For example, when the display size of the target network video in the page is 1280×720, the ratio is calculated out as 16:9.

Since, in the process of stretching, there is a difference between the size of the target network video and the full-screen size of the smart television, the stretched target network video may be subjected to image distortion when being displayed on the full screen. Once the image distortion occurs, it may interfere with user's watching effect and deteriorate user experience. Therefore, when the judging module 24 judges that the target network video ratio falls into the predefined stretchable range, i.e., it is stretched without distortion, then trigger the stretching module 23 to stretch the target network video; otherwise, trigger the playback module 26 not to stretch it.

The predefined stretchable range is a range in which the stretched target network video is not subjected to distortion, including: a 0.8˜1.2 ratio of the aspect ratio of the full-screen size of the smart television to the target network video ratio, wherein the target network video ratio is an aspect ratio of the display size of the target network video in the page.

The playback module 26 is configured to play back the target network video with the display size of the target network video in the page.

When the target network video ratio does not fall into the predefined stretchable range, i.e., it is stretched with distortion, the player will not stretch and play back the target network video on the full screen rather than triggering the playback module 26 to play back the target network video with the display size of the video in the page.

Herein, the inquiry module 25 is configured to generate an inquiry message to inquire whether to play back on full screen, display it on the smart television screen, judge whether the received message is a message to determine the full-screen playback, and if yes, trigger the stretching module 23 to stretch the target network video; otherwise, trigger the playback module 26 not to stretch it.

The user may determine whether to play back on full screen according to his/her own preference or habits. Before the player stretches the target network video, the inquiry module 25 may generate the inquiry message to inquire whether to play back on full screen and display the inquiry message on the smart television screen, to provide the user with option to stretch or not. The user may choose to play back on full screen or not to play back on full screen by himself or herself via a controller (such as a remote control). A feedback message can be generated and sent to the smart television.

After the player receives the feedback message, the inquiry module 25 may judge whether the message is a message to determine the full-screen playback. If yes, trigger the stretching module 23 to stretch the display size of the target network video in the page on the basis of the full-screen size of the smart television, to allow for the full-screen playback of the target network video on the screen of the smart television.

If the message acquired by the player is not a message to determine the full screen playback, then the full screen playback would be negated. In this regard, the player will no longer stretch the target network video, but trigger the playback module 26 to play back the target network video with the display size of the video in the page.

In an implementation, it is also possible to first judge whether the ratio of the target network video satisfies the predefined stretchable range, and if yes, directly stretch and playback the target network video on full screen; otherwise, inquire whether to provide the full screen playback and prompt the user that the distortion may occur if full screen is applied. Then whether to stretch can be judged according to the user's feedback message.

In conclusion, in the device for adjusting video playback interface provided in this embodiment, the player may further include: a judging module, an inquiry module and a playback module, wherein the judging module is configured to calculate out a ratio of the target network video on the basis of the display size of the target network video in the page, judge whether the ratio of the target network video falls into a predefined stretchable range, and if yes, trigger the stretching module; otherwise, trigger the playback module; the inquiry module is configured to generate an inquiry message to inquire whether to play back on full screen, display it on the smart television screen, judge whether the received message is a message to determine the full-screen playback, and if yes, trigger the stretching module; otherwise, trigger the playback module; and the playback module is configured to play back the target network video with the display size of the target network video in the page. The target network video will be stretched when it falls into the stretching requirement; otherwise not stretched, thereby ensuring that the stretched video images are played back without distortion. Before the target network video is stretched, the player can also propose an inquiry message to inquire whether to stretch. The user may determine whether to stretch on the basis of his or her own use habits, thereby improving user's participation and providing better user experience.

The present disclosure also provides specific application scenarios of the method for adjusting video playback interface in practice.

A specific flow chart of an application scenario is shown in FIG. 11.

Step S201: selecting a target network video in a browser webpage of a smart television by a user and generating request message.

The user may select a desirable target network video to watch in the webpage displayed on the smart television via a controller (such as, a remote control).

Step S202: receiving a request message and opening a webpage of the target network video by the browser.

After the browser receives the request message, the browser may be opened to acquire a video tag of the webpage, and the video tag may be parsed to acquire a display size of the target network video in the page and an actual playback address of the video.

Step S203: invoking a player by the browser and activating the player.

The browser may send a call request for invoking the player in order to play back the target network video on the smart television by the player.

The player is activated, and then the target network video is available according to the actual playback address.

Step S204: stretching the display size of the target network video in the page by the player, allow for a full screen playback of the target network video on a screen of the smart television.

After acquiring the target network video, the player can stretch the video such that the screen of the smart television is filled with the video during playback. Therefore, the full screen playback is realized.

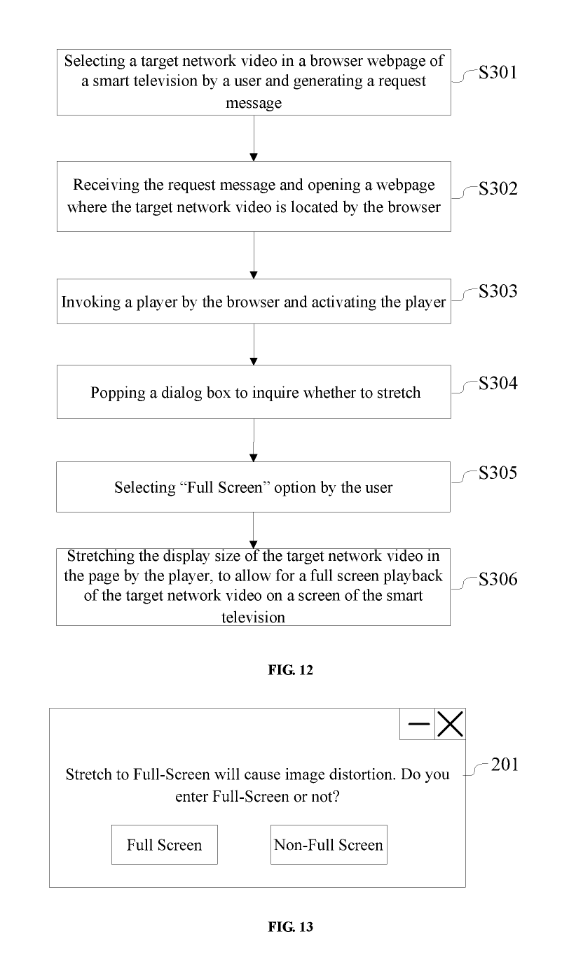

A specific flow chart of another application scenario is shown in FIG. 12.

Step S301: selecting a target network video in a browser webpage of a smart television by a user and generating a request message.

The user may select a desirable target network video to watch in the webpage displayed on the smart television via a controller (such as, a remote control).

Step S302: receiving the request message and opening a webpage where the target network video is located by the browser.

After the browser receives the request message, the browser may be opened to acquire a video tag of the webpage, and the video tag may be parsed to acquire a display size of the target network video in the page and an actual playback address of the video.

Step S303: invoking a player by the browser and activating the player.

The browser may send a call request for invoking the player in order to play back the target network video on the smart television by the player.

The player is activated, and then the target network video is available according to the actual playback address.

Step S304: popping a dialog box to inquire whether to stretch.

When the browser acquires the target network video, it can calculate out that the ratio of the video is 20:9 while the full screen aspect ratio of the smart television is 16:9. If the video is stretched up to the full screen, distortion may occur. In this regard, the player can generate a prompt message and pop a dialog box (as shown in FIG. 13) on the screen of the smart television. The dialog box 201 shows “Stretch-to-Full-Screen will cause image distortion. Do you enter Full Screen or not?”, and provides two options “Full Screen” and “Non-Full Screen”. The dialog box will disappear after the user clicks either of the options.

Step S305: selecting “Full Screen” option by the user.

Step S306: stretching the display size of the target network video in the page by the player, to allow for a full screen playback of the target network video on a screen of the smart television.

After acquiring the target network video, the player can stretch the video such that the screen of the smart television is filled with the video during playback. Therefore, the full screen playback is realized.

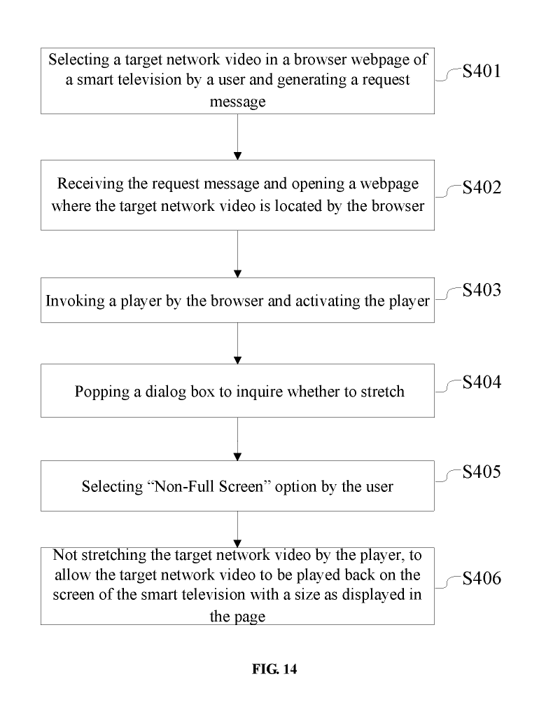

A specific flow chart of another application scenario is shown in FIG. 14.

Step S401˜Step S404 in this application scenario is the same as Step S301˜Step S304 in the second application scenario, description of which is omitted herein.

Step S405: selecting “Non-Full Screen” option by the user.

Step S406: not stretching the target network video by the player, to play back the target network video on the screen of the smart television with a size as displayed in the page.

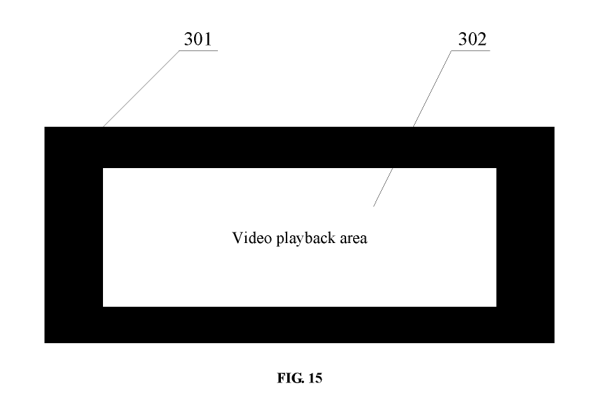

After receiving a message not to stretch to the full screen, the player will not stretch the video but play back the video with its initial size. FIG. 15 shows a schematic diagram of the smart television screen 301. While a video playback area 302 does not fill the smart television screen 301, the black borders are added to unfilled areas.

In the embodiments of the present disclosure, the browser can acquire the video tag of the webpage where the target network video is located and parse the video tag to obtain the display size of the target network video in the page and the actual playback address of the video. However, the present disclosure is not limited thereto. In a practical implementation, in order to simplify the parsing process, only the actual playback address of the video may be parsed out; in the process of stretching the target network video, the step of directly stretching the target network video to the full screen can be executed regardless of its size; and the step of parsing the display size of the target network video in the page can be eliminated and set by the user or manufacturer instead, explanation of which will be omitted in the embodiments of the present disclosure.

The method and device for adjusting video playback interface according to the present disclosure have been described in detail. Herein the principles and implementations of the present disclosure are illustrated by way of specific examples. The embodiments described above are only intended to help understand the method and main concept of the present disclosure. Meanwhile, for an ordinary skilled person in the art, variations could be made to the specific implementations and their application scope in accordance with concepts of the present disclosure. In summary, the contents of the specification should not be construed as limiting of the present disclosure.

1. A method for adjusting video playback interface, characterized in that the method is applicable to a smart television and comprises steps of:
a browser opening a webpage where a target network video is located on the basis of a received request message requesting for the target network video;
the browser acquiring a video tag of the webpage, and parsing the video tag to obtain a display size of the target network video in the page and actual playback address of the video;
the browser invoking the player in the smart television;
the player receiving a call request of the browser and acquiring the target network video on the basis of the received actual playback address of the target network video to be played back as requested; and
the player stretching the display size of the target network video in the page on the basis of the full-screen size of the smart television, to allow for the full-screen playback of the target network video on a screen of the smart television.

2. The method according to claim 1, characterized in that the size comprises a height and a width, and the step of the player stretching the display size of the target network video in the page on the basis of the full-screen size of the smart television, comprises:
the player stretching a width of the target network video as displayed in the page to a width of the full-screen size; and
the player stretching a height of the target network video as displayed in the page to a height of the full-screen size.

3. The method according to claim 1, characterized in that the step of the browser acquiring a video tag of the webpage and parsing the video tag to obtain a display size of the target network video in the page and actual playback address of the video, comprises:
acquiring a tag a of the webpage and acquiring webpage address URL of the target network video on the basis of the tag a;
loading a corresponding HTML5 video page which comprises a HTML5 video tag on the basis of the URL; and
invoking a JavaScript function to parse the HTML5 video tag, to obtain the display size of the target network video in the page and the actual playback address of the video.

4. The method according to claim 1, characterized in that after the step of acquiring the target network video on the basis of the received actual playback address of the target network video to be played back as requested, and before the step of the player stretching the display size of the target network video in the page on the basis of the full-screen size of the smart television, the method further comprises:
the player calculating out a ratio of the target network video on the basis of the display size of the target network video in the page and judging whether the ratio of the target network video falls into a predefined stretchable range, and if yes, stretching the display size of the target network video in the page to the full-screen size;
otherwise, playing back the target network video with the display size of the target network video in the page.

5. The method according to claim 4, characterized in that the predefined stretchable range is a range in which the stretched target network video is not subjected to distortion, comprising: a 0.8˜1.2 ratio of the aspect ratio of the full-screen size of the smart television to the target network video ratio, wherein the target network video ratio is an aspect ratio of the display size of the target network video in the page.

6. The method according to claim 1, characterized in that after the step of acquiring the target network video on the basis of the received actual playback address of the target network video to be played back as requested, and before the step of the player stretching the display size of the target network video in the page on the basis of the full-screen size of the smart television, the method further comprises:
the player generating an inquiry message to inquire whether to play back on full screen and displaying it on the smart television screen;
when receiving a message to determine the full-screen playback, the player stretching the display size of the target network video in the page on the basis of the full-screen size of the smart television;
otherwise, the player playing back the target network video with the display size of the target network video in the page.

7. A smart television for adjusting video playback interface, characterized in that, the smart television comprises:
a memory having instructions stored thereon;
a processor configured to execute the instructions to perform operations for adjusting video playback interface, comprising;
opening a webpage where a target network video is located on the basis of received request message requesting for the target network video, acquiring a video tag of the webpage, parsing the video tag to obtain a display size of the target network video in the page and actual playback address of the video, and invoking the player in the smart television; and
receiving a call request of the browser, acquiring the target network video on the basis of the received actual playback address of the target network video to be played back as requested, and stretching the display size of the target network video in the page on the basis of the full-screen size of the smart television to allow for a full-screen playback of the target network video on a screen of the smart television.

8. The smart television according to claim 7, characterized in that the processor is further configured to perform:
opening a webpage where a target network video is located on the basis of received request message requesting for the target network video;
acquiring a video tag of the webpage;
parsing the video tag to obtain a display size of the target network video in the page and actual playback address of the video; and
invoking the player in the smart television, and
receiving the call request;
acquiring the target network video on the basis of the received actual playback address of the target network video to be played back as requested; and
stretching the display size of the target network video in the page on the basis of the full-screen size of the smart television, to allow for the full-screen playback of the target network video on the screen of the smart television.

9. The smart television according to claim 8, characterized in that the processor is further configured to perform:
acquiring a tag a of the webpage and acquire webpage address URL of the target network video on the basis of the tag a;
on the basis of the URL, loading a corresponding HTML5 video page which comprises a HTML5 video tag; and
invoking a JavaScript function to parse the HTML5 video tag, to obtain the display size of the target network video in the page and the actual playback address of the video.

10. The smart television according to claim 8, characterized in that the size comprises a height and a width, and the processor is further configured to perform:
stretching a width of the target network video as displayed in the page to a width of the full-screen size; and
stretching a height of the target network video as displayed in the page to a height of the full-screen size.

11. A computer readable recording medium having computer programs stored thereon that, when executed by one or more processors of an electronic apparatus, cause the electronic apparatus to perform:
a browser opening a webpage where a target network video is located on the basis of a received request message requesting for the target network video;
the browser acquiring a video tag of the webpage and parsing the video tag to obtain a display size of the target network video in the page and actual playback address of the video;
the browser invoking the player in the smart television;
the player receiving a call request of the browser and acquiring the target network video on the basis of the received actual playback address of the target network video to be played back as requested; and
the player stretching the display size of the target network video in the page on the basis of the full-screen size of the smart television, to allow for the full-screen playback of the target network video on a screen of the smart television.
